(19) United States
(12) Patent Application Publication
(10) Pub. No.: US 2002/0158837 A1
(43) Pub. Date: Oct. 31, 2002

(54) Input device with a covering device

(76) Inventor: Ding-Teng Hou, Xi-Zhi City (TW)

Correspondence Address: Raymond Sun, 12420 Woodhall Way, Tustin, CA, 92782, US

(21) Appl. No.: 09/844,792

(22) Filed: Apr. 27, 2001

(51) Int. Cl. G09G 5/00

(52) U.S. Cl. 345/156

(57) ABSTRACT

An input device has a housing with an opening, and a cover pivotally coupled to the housing in a manner such that the cover can assume an open position where the cover is pivoted away from the opening to expose the opening to ambience, and a closed position where the cover completely covers the opening from ambience.

### BACKGROUND OF THE INVENTION

1. Field of the Invention

The present invention relates to a covering device, and in particular, to a covering device that is coupled with a computer input device so as to protect an add-on device that is located within the input device.

2. Description of the Prior Art

With the advancement of technology, many add-on devices and equipments are being provided together with input devices (such as computer mice, touch pads, pointers, etc.). Examples of these add-on devices include data gathering devices, storage devices, finger print identification devices, smart card reading devices, and memory card (or memory stick) reading/storing devices. Unfortunately, in the current design of many input devices, a portion of any add-on device provided with these input devices will be exposed to the ambience for a number of reasons, including to provide access for the confirmation of a user's identification or fingerprints, or to allow the input of a variety of data stored in a memory card/stick, or to allow the input of a code. However, the exposure of such add-on devices may reduce not only the life span of the add-on devices, but also the reliability of the operation of the input device. In addition, the exposure of an add-on device to the ambience will affect the outward appearance of the input device, and in certain circumstances, may hinder the convenient use and operation of the input device by the user.

In a known prior design, a lid is used to protect one or more batteries inside a wireless input device. Since the batteries are rarely changed, the lid is fixed to the housing of the input device by a relatively permanent connection, such as by screws.

Unfortunately, the use of screws suffers from the serious drawback that it is very inconvenient to access the device (e.g., batteries) stored therein, and this is not an acceptable solution for add-on devices that require relatively frequent access by the user.

### SUMMARY OF THE DISCLOSURE

It is an object of the present invention to provide a movable covering device for use in protecting an add-on device positioned inside an input device, so as to protect the add-on device from external contamination by dust and the like.

It is another object of the present invention to provide a movable covering device for an input device that provides convenient access to the add-on device.

It is yet another object of the present invention to provide a liftable covering device for an input device.

It is yet another object of the present invention to provide a locking mechanism for releasably locking the covering device to the input device.

It is yet another object of the present invention to provide a covering device for an input device that can be conveniently used and operated by both a right-handed person and a left-handed person.

In order to accomplish the objects of the present invention, the present invention provides an input device having a housing with an opening, and a cover pivotally coupled to the housing in a manner such that the cover can assume an open position where the cover is pivoted away from the opening to expose the opening to ambience, and a closed position where the cover completely covers the opening from ambience.

### BRIEF DESCRIPTION OF THE DRAWINGS

FIG. 1 is a perspective view of an input device according to the present invention shown with the cover in a closed position.

FIG. 2 is a perspective view of the input device of FIG. 1 shown with the cover in an open position.

FIG. 3 is a cross-sectional view of the input device of FIG. 1.

FIG. 4 is an exploded perspective view of the input device of FIG. 1 showing the arrangement for the upper housing.

FIG. 5 is an exploded perspective view of the input device of FIG. 1 showing the arrangement for the lower housing.

FIG. 6 is a perspective view of the input device of FIG. 1 showing the using of a smart card when the cover is in the open position.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

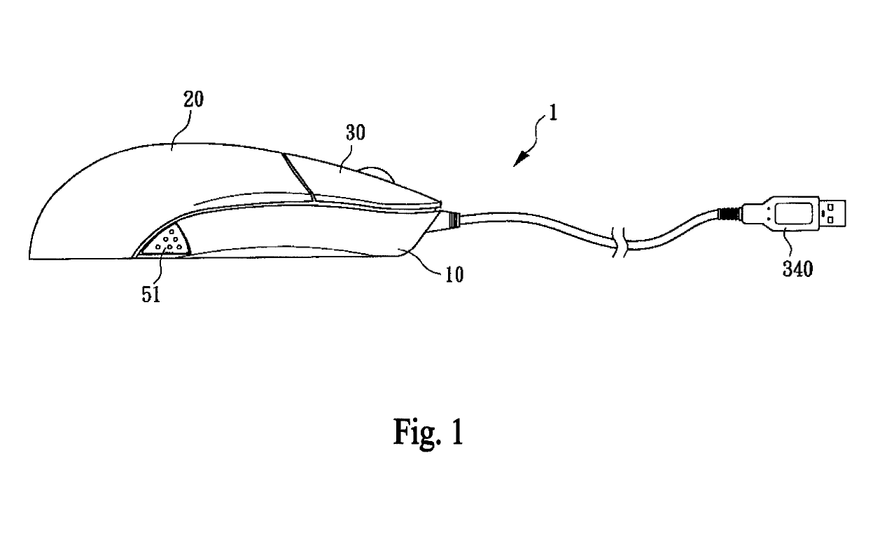

FIGS. 1-3 illustrate an input device 1 according to one embodiment of the present invention. The input device 1 can be a computer mouse having an add-on device provided therein. The add-on device can be a data gathering or storage device, a biometric identification device (such as a retina identification device), smart card, memory card, memory stick reading or storage device, code input device, etc.

The input device 1 has a main body 10 that has an upper housing 102 and a lower housing 101 that together form an interior space 100. The input device 1 also has a plurality of keys 30 provided on the upper housing 102 using techniques that are known in the art. A connector 340 extends from the main body 10 via a cable. An add-on device 70 is provided inside the interior space 100. The input device 1 further includes a lock mechanism 40, a release mechanism 50, a pivoting mechanism 60, and a printed circuit board (PCB) 71 that embodies other known and conventional components of an input device (which are not described in any further detail because such components and their operations are well-known in the art). The lock mechanism 40, the release mechanism 50 and the PCB 71 and other conventional components are positioned inside the space 100. The input device 1 can be a wired or wireless input device.

A covering device is operatively associated with the upper housing 102 for covering or shielding the add-on device 70 positioned inside the main body 10. The covering device can be moveable between an open position and a closed position, and has a liftable cover 20 as described hereinbelow. The cover 20 can be pivoted on the upper housing 102, and is operatively coupled to the lock mechanism 40, the release mechanism 50, and the pivoting mechanism 60 to facilitate convenient operation of the cover 20. The cover 20 can be conveniently replaced by other covers 20 having the same construction, but having different colors or shapes.

The construction and operation of the upper housing 102 and the lower housing 101, the plurality of keys 30, the add-on device 70, and the PCB 71 and other conventional components are all well-known in the art, and will not be described in greater detail herein.

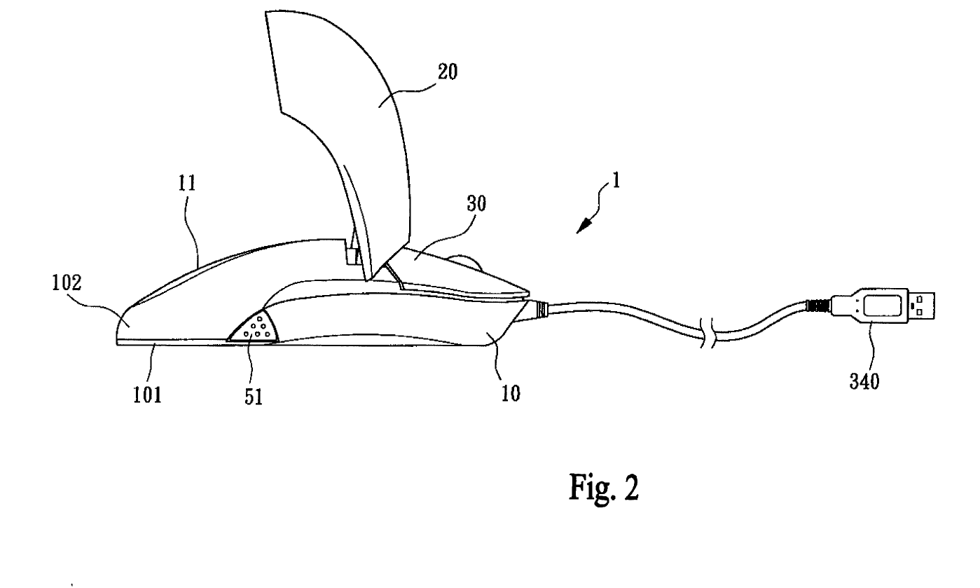

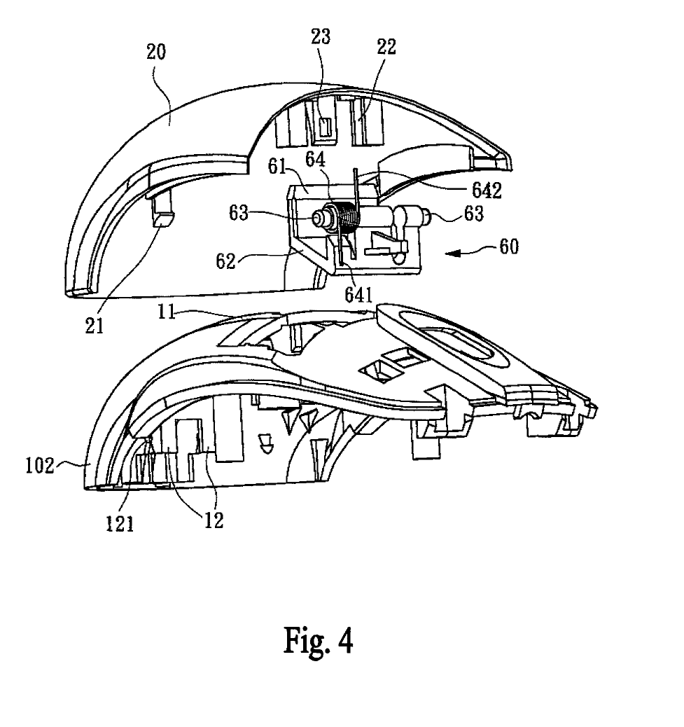

Referring now to FIGS. 2-5, the add-on device 70 has a reception portion 11 that is normally exposed to the ambience via an opening 111 in the upper housing 102. The reception portion 11 can be covered by the cover 20 (see FIG. 2). The reception portion 11 allows a user to input data that can be information data, or merely identification data to verify the identity of the user for security purposes. For example, if correct identification data is not inputted, the input device 1 can be programmed to not function. The cover 20 can be pivoted on the upper housing 102 between an open position and a closed position. When the cover 20 is in the closed position, the cover 20 shields or covers the reception portion 11 to protect the add-on device 70 from ambient contamination. In addition, the cover 20 provides a sleek and visually-appealing profile and design (see FIG. 1) when the cover 20 is in the closed position, which also makes it easier for the user to access the keys 30 and other control buttons during normal operation of the input device 1.

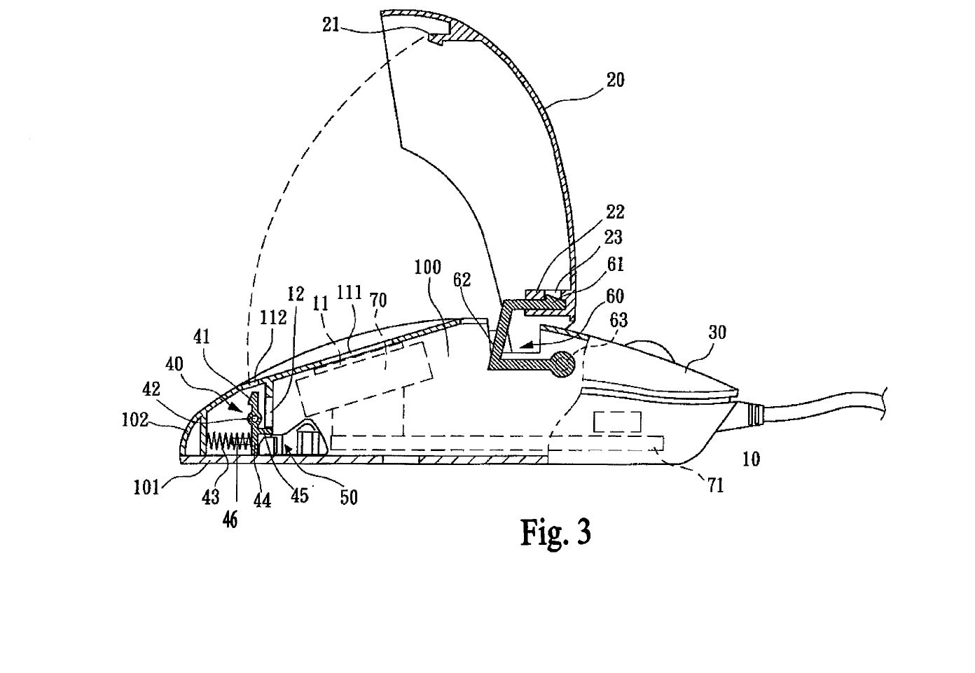

The lock mechanism 40 is provided within the interior space 100 and functions to lock the cover 20 with the main body 10 when the cover 20 is in the closed position. The lock mechanism 40 includes a hook-shaped latch 41 seated on a pivot 42, a push board 44 extending from below the pivot 42, a stopping block 45 extending transversely from the stopping block 45, and a shaft 46 that extends transversely from the stopping block 45 in a direction opposite to that of the stopping block 45. A relocating element 43 is supported on the shaft 46. A hook 21 is provided on the inner surface of the cover 20, and is adapted to hook or catch the latch 41 to lock the cover 20 to the main body 10. A pivot opening 121 is provided in the upper housing 102 at a position so that it can receive an end of the pivot 42. A stopper 12 also extends from the upper housing 102. The pivot 42 is pivoted about the pivot opening 121, which in turn causes the latch 41 and the push board 44 to be pivoted to a limited degree. When the cover 20 is in the closed position, the hook 21 extends through an aperture 112 in the upper housing 102 to be locked together with the latch 41. In this embodiment, the relocating element 43 can be a compressed spiral spring positioned on the shaft 46 against one side of the push board 44 to normally bias the stopping block 45 against the stopper 12. This bias produced by the relocating element 43 causes a counter-clockwise pivot (as viewed from FIG. 3) of the stopping block 45 and the latch 41, which causes the latch 41 to be biased into engagement with the hook 21. This ensures that the latch 41 is locked together with the hook 21 of the cover 20.

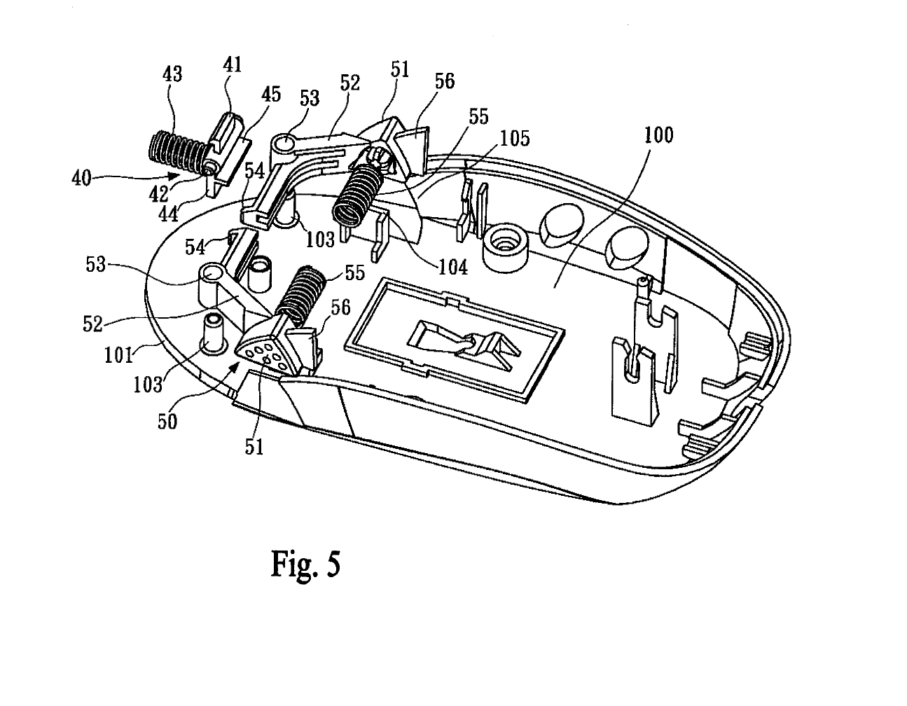

Referring now to FIG. 5, a pair of release mechanisms 50 are positioned inside the main body 10 to push or otherwise actuate the push board 44 of the lock mechanism 40. By depressing one or both of the release mechanisms 50, at least one of the two release mechanisms 50 will exert a force on the push board 44 that overcomes the the bias of the relocating element 43 to pivot the push board 44 and the latch 41 in a clockwise direction (as viewed from FIG. 3), thereby releasing the engagement between the latch 41 and the hook 21 so that the lock mechanism 40 will release the cover 20 such that the cover 20 can be lifted to the open position.

In the present embodiment, a pair of release mechanisms 50 are respectively located at opposing sides of the main body 10 so that right-handed and left-handed users can operate the release mechanisms 50 with ease. Each release mechanism 50 has the same construction, so only one release mechanism 50 will be described. Each release mechanism 50 has an active button 51, an active connecting arm 52 and a resilient element 55. At least a portion of the button 51 is exposed to the ambience through appropriate openings in the main body 10. The active connecting arm 52 has a first end coupled to the active button 51, and a second end having a push end 54 that is adapted to push the push board 44. The connecting arm 52 further includes a pivot opening 53 that is positioned between the push end 54 and the button 51. A pivoting pillar 103 is provided on the lower housing 101, and is adapted to be fitted inside the pivot opening 53 so that the connecting arm 52 can be pivoted about the pillar 103.

The resilient element 55 can be a compressed spiral spring, with one end of the spring 55 positioned against the active button 51, and the opposing end of the spring 55 abutting against a positioning block 104 that is provided on the lower housing 101. Thus, the resilient element 55 normally biases the active button 51 in an outward direction away from the main body 10. In this regard, the active button 51 has a positioning wing 56 that abuts against the inside surface of the lower housing 101 to prevent the resilient element 55 from biasing the active button 51 completely out of the main body 10. When the active button 51 is depressed, the connecting arm 52 will pivot about the pillar 103 such that the push end 54 exerts a force against the push board 44 in a direction opposite to the bias of the relocating element 43.

Referring now to FIGS. 3-5, the cover 20 is pivotally coupled with the main body 10 by a pivoting mechanism 60. The cover 20 has a slot 22 which is positioned adjacent the pivoting mechanism 60. The pivoting mechanism 60 includes a connection arm 62 and a relocating spring 64. The connection arm 62 has a pivot axle 63 provided at one end thereof, and a snap fastener 61 (which can be configured in the form of a hook) at the other end thereof, with the pivot axle 63 pivotally coupled with the main body 10. The snap fastener 61 can be removably secured into a snap opening 23 provided in the slot 22. If the user desires to replace the cover 20 with a new cover 20, the user can easily remove the cover 20 by separating the snap fastener 61 from the snap opening 23.

The pivot axle 63 pivots the cover 20 between the closed position and the open position. The relocating spring 64 provides a rebounding force or bias to lift the cover 20 to the open position. In this embodiment of the present invention, the relocating spring 64 can be a torque spring that is fitted onto and about the pivot axle 63. The relocating spring 64 has two opposing ends, the first end 641 that is normally positioned against the connection arm 62 and a second end 642 that is normally positioned against the inside of the main body 10. This positioning of the ends 641 and 642 of the spring 64 allows the spring 64 to bias the cover 20 to the open position when the latch 41 is released from its engagement with the hook 21.

FIG. 1 illustrates the cover 20 of the input device 1 in the normal closed position, where the lock mechanism 40 locks the cover 20 onto the main body 10 such that the cover 20 not only can protect the add-on device 70 from external contamination, but also provides an aesthetically pleasing appearance for the input device 1, while allowing the user to operate the input device 1 without being inconvenienced by the add-on device 70.

FIG. 2 illustrates the cover 20 of the input device 1 in the open position. To reach the open position for the cover 20, the user presses on either or both of the active buttons 51, which pivots the connecting arm(s) 52 about the pivot opening(s) 53, causing the push end(s) 54 to pivot against the push board 44. The force from the push end(s) 54 against the push board 44 overcomes the bias of the relocating element 43, thereby pivoting the pivot 42 and the latch 41 in a clockwise direction (as viewed from FIG. 3). The latch 41 therefore releases its engagement with the hook 21, and the spring 64 of the pivoting mechanism 60 will automatically bias the cover 20 to the open position.

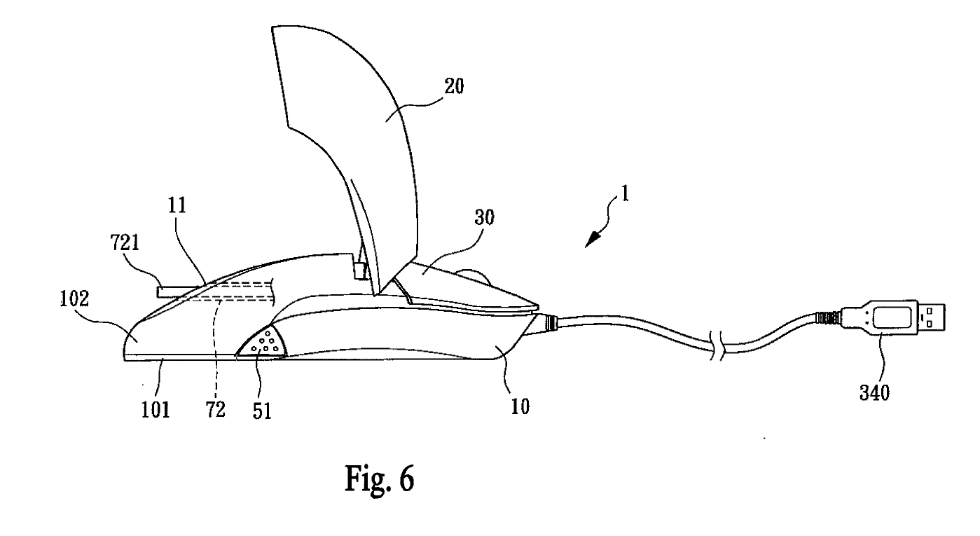

FIG. 6 illustrates another application showing the use of a smart card 721. The add-on device 70 shown in FIGS. 2 and 3 can be a smart card gathering device 72. The user presses on either side of the active button 51 to release the lock mechanism 40 so as to unlock the cover 20 to the open position, and then the user inserts a smart card 721 into the smart card gathering device 72 to identify the user.

As a further application of the present invention, if the input device 1 is a wireless device, the cover 20 can provide protection for a power supply device (not shown) located within the interior space 100.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An input device, comprising:
a housing having an opening; and
a cover pivotally coupled to the housing in a manner such that the cover can assume an open position where the cover is pivoted away from the opening to expose the opening to ambience, and a closed position where the cover completely covers the opening from ambience.

2. The device of claim 1, further including an add-on device that is retained inside the housing and having a portion thereof which extends through the opening, with the add-on device being completely covered by the cover in the closed position.

3. The device of claim 1, wherein the housing has a top surface, and wherein the opening is provided on the top surface and the cover is pivotally coupled to the top surface of the housing.

4. The device of claim 1, further including a locking mechanism that releasably secures the cover to the housing.

5. The device of claim 4, wherein the locking mechanism includes a hook that extends from the cover, and a latch which is normally biased to engage the hook.

6. The device of claim 4, further including a release mechanism that is operatively coupled to the locking mechanism to release the cover from the housing.

7. The device of claim 6, wherein the release mechanism includes a handle that is external to the housing and which is normally biased in a direction away from the housing, and a connecting arm having a first end coupled to the handle and a second end contacting the locking mechanism.

8. The device of claim 7, wherein the locking mechanism includes a hook that extends from the cover, and a latch is normally biased to engage the hook, and wherein the second end of the connecting arm contacts the latch and overcomes the bias on the latch when the button is pressed.

9. The device of claim 1, further including a pivot mechanism having a first end pivotally coupled to the housing, and a second end secured to the cover.

10. The device of claim 9, wherein the pivot mechanism further includes a resilient element that normally biases the cover to pivot to the open position.

11. The device of claim 2, wherein the add-on device is selected from the group consisting of an identification device, a retina identification device, a smart card, a memory card, a memory stick reading or storage device, a memory gathering device, a power supply device, and a code input device.

12. An input device, comprising:
a housing having an opening;
a cover pivotally coupled to the housing in a manner such that the cover can assume an open position where the cover is pivoted away from the opening to expose the opening to ambience, and a closed position where the cover completely covers the opening from ambience;
a locking mechanism that releasably secures the cover to the housing; and
a release mechanism that is operatively coupled to the locking mechanism to release the cover from the housing.

13. The device of claim 12, further including an add-on device that is retained inside the housing and having a portion thereof which extends through the opening, with the add-on device being completely covered by the cover in the closed position.

14. The device of claim 12, wherein the locking mechanism includes a hook that extends from the cover, and a latch which is normally biased to engage the hook.

15. The device of claim 14, wherein the release mechanism includes a handle that is external to the housing and which is normally biased in a direction away from the housing, and a connecting arm having a first end coupled to the handle and a second end contacting the locking mechanism, wherein the second end of the connecting arm contacts the latch and overcomes the bias on the latch when the button is pressed.

16. An input device, comprising:
a housing having an opening;
a cover pivotally coupled to the housing in a manner such that the cover can assume an open position where the cover is pivoted away from the opening to expose the opening to ambience, and a closed position where the cover completely covers the opening from ambience;
a locking mechanism that releasably secures the cover to the housing;
a release mechanism that is operatively coupled to the locking mechanism to release the cover from the housing; and
a pivot mechanism having a first end pivotally coupled to the housing, and a second end secured to the cover.

17. The device of claim 16, further including an add-on device that is retained inside the housing and having a portion thereof which extends through the opening, with the add-on device being completely covered by the cover in the closed position.

18. The device of claim 16, wherein the locking mechanism includes a hook that extends from the cover, and a latch which is normally biased to engage the hook.

19. The device of claim 18, wherein the release mechanism includes a handle that is external to the housing and which is normally biased in a direction away from the housing, and a connecting arm having a first end coupled to the handle and a second end contacting the locking mechanism, wherein the second end of the connecting arm contacts the latch and overcomes the bias on the latch when the button is pressed.

20. The device of claim 16, wherein the pivot mechanism further includes a resilient element that normally biases the cover to pivot to the open position.
